(19) United States
(12) Patent Application Publication
(10) Pub. No.: US 2026/0019012 A1
(43) Pub. Date: Jan. 15, 2026

(54) LAMINATED PIEZOELECTRIC SHEET

(71) Applicant: Mitsubishi Chemical Corporation, Tokyo (JP)

(72) Inventors: Itaru WATANABE, Nagahama-shi (JP); Hiroto YAMADA, Ogaki-shi (JP)

(73) Assignee: Mitsubishi Chemical Corporation, Tokyo (JP)

(21) Appl. No.: 19/333,762

(22) Filed: Sep. 19, 2025

Related U.S. Application Data
(63) Continuation of application No. PCT/JP2024/008755, filed on Mar. 7, 2024.

(30) Foreign Application Priority Data
Mar. 22, 2023 (JP) 2023-045740
Mar. 24, 2023 (JP) 2023-048483

(51) Int. Cl. H02N 1/08

(52) U.S. Cl. CPC H02N 1/08

(57) ABSTRACT

Disclosed is a laminated piezoelectric sheet having an electrode laminated on at least one surface of a piezoelectric film, in which the electrode has a raised pattern on a surface on a side in contact with the piezoelectric film. It is possible to provide a laminated piezoelectric sheet that has good signal intensity and little in-plane variation of signal intensity as well as enabling mass production.

### CROSS-REFERENCE TO RELATED APPLICATIONS

This application is a continuation of International Application PCT/JP2024/008755 filed on Mar. 7, 2024, and claims priority to Japanese application No. 2023-045740 filed on Mar. 22, 2023 and Japanese application No. 2023-048483 filed on Mar. 24, 2023 the disclosures of all of which are incorporated herein by reference in their entireties.

### TECHNICAL FIELD

The present invention relates to a laminated piezoelectric sheet, and particularly to a laminated piezoelectric sheet that can be suitably used for vibration power generation, a water level gauge, an acoustic detector, a sensor such as a mat sensor, a sensor for a robot hand, and the like.

### BACKGROUND ART

A piezoelectric film using a resin film is known to exhibit an excellent piezoelectric effect and is widely used for vibration power generation, a sensor device, and the like. As the piezoelectric film, an electret film is suitably used.

The electret is a material with semipermanently polarized in a part of the material and is obtained by thermally or electrically treating a material which is hard to conduct electricity such as a polymer material and an inorganic material.

For example, an electret using a porous resin film is known to exhibit an excellent piezoelectric effect and is widely used as a piezoelectric film in vibration power generation, a sensor device, and the like.

When the porous electret film is used as a sensor, it is necessary to provide a conductive layer for transmitting an electric signal.

As a means for providing the conductive layer, coating of a conductive coating material, vapor deposition of a metal or the like, adhesion of a metal foil or the like are generally used.

However, in the coating method, the performances of the electret may deteriorate due to permeation of the solvent or an increase in temperature at the time of drying. In addition, in the vapor deposition method, since the vaporized metal directly comes into contact with the electret, the temperature of the electret is increased, and the performances may deteriorate as in the coating method. Further, in the adhesion method, by applying an adhesive to the surface of the electret, the electric charge held in the electret is lost, and the performances may similarly deteriorate.

To solve such a problem, it has been reported that high piezoelectric characteristics can be achieved by sealing a porous electret film and an electrode without using an adhesive (PTL 1).

In addition, a method of improving adhesiveness by forming a pressure-sensitive adhesive layer only on a part of one surface of an electretized film and forming an electrode layer on the pressure-sensitive adhesive layer has also been reported (PTL 2).

Furthermore, it has been reported that high piezoelectric characteristics can be achieved by embossing the surface of a porous electret film and devising the contact with an electrode (PTL 3).

### CITATION LIST

### Patent Literature

PTL 1: JP 2021-097107 A
PTL 2: WO 2019/208580
PTL 3: JP 2013-214932 A

### SUMMARY OF INVENTION

### Technical Problem

However, in the laminated piezoelectric sheet described in PTL 1, the signal intensity may greatly vary depending on the position in a large-sized sensor device. In addition, in the electretized laminate described in PTL 2, since a part of the electretized film is deactivated by the pressure-sensitive adhesive layer, sufficient piezoelectric characteristics may not be obtained. Furthermore, the electret film described in PTL 3 has a complicated production process and is not suitable for mass production, and the signal intensity of the sensor may not be improved depending on the size and interval of concave and convex. In addition, in the electret film described in PTL 3, since the charging treatment is performed after providing concave and convex on the surface of a foamed sheet, there is a case where a deviation occurs in a charge amount between a concave portion and a convex portion, and an in-plane variation of signal intensity occurs.

Therefore, an object of the present invention is to provide a laminated piezoelectric sheet that has good signal intensity and little in-plane variation of signal intensity while enabling mass production.

### Solution to Problem

The present inventors have conducted intensive studies in order to achieve the above object.

In a laminated piezoelectric sheet of the related art, a flat electrode having no concave and convex on the surface is generally used, but the present inventors have studied formation of concave and convex having a specific shape on the electrode. When concave and convex are formed on the electrode, a space can be formed between the piezoelectric film and the electrode, and therefore, when an external pressure is applied to the laminated piezoelectric sheet, the deformation is likely to be transmitted to the piezoelectric film. From this viewpoint, the shape of the concave and convex formed on the electrode was variously studied, and it was found that there is an optimal value for the height of the concave and convex. In addition, it has been found that there is also an optimum value for the interval of the concave and convex because the in-plane variation of the signal intensity is likely to occur when the interval of the concave and convex is too wide.

Namely, the gist of the present invention is as follows.
[1] A laminated piezoelectric sheet including an electrode laminated on at least one surface of a piezoelectric film, in which the electrode has a raised pattern on a surface on a side in contact with the piezoelectric film.
[2] The laminated piezoelectric sheet according to the item [1], in which the laminated piezoelectric sheet has an electrode laminated on at least one surface of a piezoelectric film, a maximum cross-sectional height (Rt) on a surface of the electrode on a side in contact with the piezoelectric film is 20 μm or more, and a concave-convex average interval (Sm) is 40 mm or less.
[3] The laminated piezoelectric sheet according to the item [1] or [2], in which a ratio (Rt/Sm) of the maximum cross-sectional height (Rt) to the concave-convex average interval (Sm) on a surface of the electrode on a side in contact with the piezoelectric film is 2.5×10⁻³ or more and 35×10⁻³ or less.
[4] The laminated piezoelectric sheet according to any one of the items [1] to [3], in which a surface of the electrode on a side in contact with the piezoelectric film has at least one pattern shape selected from a dot shape, a lattice shape, a stripe shape, and a combination thereof.
[5] The laminated piezoelectric sheet according to any one of the items [1] to [4], in which the piezoelectric film is an electret film.
[6] The laminated piezoelectric sheet according to the item [5], in which the electret film has a porosity of 0% or more and 50% or less.
[7] The laminated piezoelectric sheet according to the item [5] or [6], in which the electret film is a porous film.
[8] The laminated piezoelectric sheet according to any one of the items [5] to [7], in which the electret film contains a polyolefin-based resin as a main component.
[9] The laminated piezoelectric sheet according to the item [8], in which the polyolefin-based resin is a polypropylene-based resin having a β-crystal forming ability of 80% or more.
[10] The laminated piezoelectric sheet according to any one of the items [1] to [9], in which the piezoelectric film has a thickness of 10 μm or more and 200 μm or less.
[11] The laminated piezoelectric sheet according to any one of the items [1] to [10], having a laminated structure in which the piezoelectric film, the electrode, and a protective film are provided in this order, in which a product of a flexural modulus and a thickness of the protective film is 80 kN/m or more and 10 MN/m or less.
[12] The laminated piezoelectric sheet according to any one of the items [1] to [11], in which the piezoelectric film and the electrode are not adhered to each other.
[13] The laminated piezoelectric sheet according to any one of the items [1] to [12], further including an adhesive layer between the piezoelectric film and the electrode, in which a ratio (Aa/Ae) of a covering area Aa of the adhesive layer to an area Ae of the electrode is more than 0 and 0.5 or less.
[14] A sensor device including the laminated piezoelectric sheet according to any one of the items [1] to [13].

### Advantageous Effects of Invention

The laminated piezoelectric sheet of the present invention has good signal intensity and little in-plane variation of signal intensity while being capable of mass production.

### BRIEF DESCRIPTION OF DRAWINGS

FIGS. 1(A) and 1(B) are diagrams each schematically illustrating a plan view shape of an example of a concave-convex pattern of an electrode surface on a side in contact with a piezoelectric film.

FIGS. 2(A) to 2(F) are diagrams each schematically illustrating a cross-sectional view shape of an example of a concave-convex pattern of an electrode surface on a side in contact with a piezoelectric film.

FIG. 3 is a shaping pattern on the surface of the electrode of Example 1 on the side in contact with the piezoelectric film.

### DESCRIPTION OF EMBODIMENTS

Hereinafter, embodiments of the present invention will be described in detail. However, the content of the present invention is not limited to the embodiments described below.

### <Laminated Piezoelectric Sheet>

The laminated piezoelectric sheet of the present invention (hereinafter, also referred to as “the present laminated piezoelectric sheet”) is a laminated piezoelectric sheet including an electrode laminated on at least one surface of a piezoelectric film, in which the electrode has a raised pattern on a surface on a side in contact with the piezoelectric film.

Since the present laminated piezoelectric sheet has the above-described configuration, the present laminated piezoelectric sheet has good signal intensity and little in-plane variation of signal intensity.

In addition, since the present laminated piezoelectric sheet can be obtained only by laminating at least the above-described two members, it is not necessary to use a complicated production process or a special material, and mass production is possible.

Hereinafter, the characteristics of the present laminated piezoelectric sheet will be described.

### (1) Output Voltage

The output voltage of the laminated piezoelectric sheet of the present invention is preferably 10 V or more and 1000 V or less, more preferably 15 V or more and 500 V or less, and further preferably 20 V or more and 100 V or less.

When the output voltage of the present laminated piezoelectric sheet is equal to or more than the above lower limit value, sufficient sensitivity can be obtained, for example, when the sheet is used as a sensor. On the other hand, when the output voltage of the present laminated piezoelectric sheet is equal to or less than the above upper limit value, the risk of spark discharge can be reduced when the sheet is incorporated as a sensor or an actuator.

The output voltage of the laminated piezoelectric sheet of the present invention is measured by a method described later.

### (2) Thickness

The thickness of the laminated piezoelectric sheet of the present invention is preferably 20 μm or more and 600 μm or less, more preferably 30 μm or more and 500 μm or less, further preferably 50 μm or more and 400 μm or less, still further preferably 70 μm or more and 300 μm or less, and particularly preferably 200 μm or less.

When the thickness of the present laminated piezoelectric sheet is 20 μm or more, the responsiveness becomes good. On the other hand, when the thickness of the present laminated piezoelectric sheet is 600 μm or less, the present laminated piezoelectric sheet can be conveyed and wound in a roll-to-roll manner, and the subsequent processing becomes easy, so that the mass productivity becomes higher.

The thickness of the laminated piezoelectric sheet is measured by randomly measuring 10 points using a dial gauge of 1/1000 mm and calculating an average value.

Next, the configuration of each layer of the present laminated piezoelectric sheet will be described.

### 1. Piezoelectric Film

The laminated piezoelectric sheet of the present invention includes at least one piezoelectric film.

Examples of the piezoelectric film include an electret film and a triboelectric film, and the electret film is preferable from the viewpoint of further enhancing the piezoelectric characteristics.

The electret film is a film charged by polarization of the film itself, and it is mainly classified into two types, a permanent dipole type polarized by dipole orientation of a polymer itself, and a porous membrane type in which a porous polymer film is subjected to a charging treatment to trap charges inside bubbles and form polarization in each pore.

The former has a dipole polarized at a molecular level, that is, a size on the order of Å to nm, and thus is preferable in that the variation in the sensitivities depending on the position is small. On the other hand, the latter porous membrane type generally has a dipole having a size of nm to μm, which is larger than that of the permanent dipole type electret film, because the dipole size depends on the size of the pores. Therefore, the porous membrane type electret film tends to have high piezoelectricity and excellent sensitivity.

The type of the electric film is not particularly limited as long as the electric film has piezoelectric characteristics, and the electric film is preferably a porous film from the viewpoint of further enhancing the piezoelectric characteristics. In addition, as the electret film, a film obtained by charging a porous film is more preferably used.

In a case where the electric film is a porous film, the method for making the film porous is not particularly limited, and examples thereof include chemical or physical foaming and making the film porous by stretching. Among these, from the viewpoint of obtaining a dense porous structure and easily controlling the shape of the pores, making the film porous by stretching is preferable.

On the other hand, since the triboelectric film is excellent in water resistance and a sensor using the triboelectric film as a piezoelectric film tends to have good water resistance, the triboelectric film is preferred depending on the application.

### <Electret Film>

Hereinafter, an electret film suitable as a piezoelectric film will be described in detail.

Examples of the material of the electret film include a polyolefin-based resin, a fluororesin, a vinyl chloride resin, a polystyrene-based resin, a butadiene-based resin, a polyester-based resin, and an acrylic-based resin, and the polyolefin-based resin is suitably used from the viewpoint that the environmental load is small and the charging treatment is easily performed.

### (1) Polyolefin-Based Resin

The electret film of the present invention preferably contains a polyolefin-based resin as a main component, and particularly preferably contains a polypropylene-based resin as a main component.

When the electret film contains a polyolefin-based resin as a main component, the content of the polyolefin resin in the electret film is preferably 50% by mass or more, more preferably 70% by mass or more and 99.9999% by mass or less, further preferably 80% by mass or more and 99.999% by mass or less, and particularly preferably 90% by mass or more and 99.99% by mass or less.

When the electret film contains a polypropylene-based resin as a main component, the content of the polypropylene resin in the electret film is preferably 50% by mass or more, more preferably 70% by mass or more and 99.9999% by mass or less, further preferably 80% by mass or more and 99.999% by mass or less, and particularly preferably 90% by mass or more and 99.99% by mass or less.

Examples of the polypropylene-based resin include homopolypropylene (propylene homopolymer), and a random copolymer or a block copolymer of propylene and an α-olefin such as ethylene, 1-butene, 1-pentene, 1-hexene, 1-heptene, 1-octene, 1-nonene, or 1-decene. Among these, homopolypropylene is more preferably used from the viewpoint of mechanical strength.

The polypropylene-based resin preferably has an isotactic pentad fraction, which indicates stereoregularity, of 80% or more and 99% or less, more preferably 83% or more and 98% or less, and further preferably 85% or more and 97% or less.

When the isotactic pentad fraction is 80% or more, the mechanical strength is good. On the other hand, the upper limit of the isotactic pentad fraction is defined by the upper limit value industrially obtainable at the present time, but this is not the case when a resin having higher regularity is developed at an industrial level in the future. The isotactic pentad fraction means a steric structure in which all of five methyl groups as side chains are positioned in the same direction with respect to a main chain formed by a carbon-carbon bond constituted of arbitrary five continuous propylene units, or a ratio thereof. The assignment of the signals in the methyl group region is in accordance with A. Zambelli et al. (Macromol. 8, 687 (1975)).

In addition, Mw/Mn, which is a parameter indicating molecular weight distribution, of the polypropylene-based resins is preferably 1.5 or more and 10.0 or less. The Mw/Mn is more preferably 2.0 or more and 8.0 or less, and further preferably 2.0 or more and 6.0 or less.

The smaller the Mw/Mn is, the narrower the molecular weight distribution is, and when the Mw/Mn is 1.5 or more, sufficient extrusion moldability can be obtained, and industrial mass production is possible. On the other hand, when the Mw/Mn is 10.0 or less, sufficient mechanical strength can be ensured.

The Mw/Mn is measured as a value in terms of polystyrene by a GPC (gel permeation chromatography) method.

The melt flow rate (MFR) of the polypropylene-based resin is not particularly limited, and the MFR is usually preferably 0.5 g/10 min or more and 15 g/10 min or less, and more preferably 1.0 g/10 min or more and 10 g/10 min or less.

By setting the MFR to 0.5 g/10 min or more, a sufficient melt viscosity can be obtained at the time of forming processing, and high productivity can be secured. On the other hand, by setting the MFR to 15 g/10 min or less, sufficient strength can be secured.

The MFR is measured in accordance with JIS K7210-1 (2014) under conditions of a temperature of 230° C. and a load of 2. 16 kg.

The method for producing the polypropylene-based resin is not particularly limited, and examples thereof include a known polymerization method using a known polymerization catalyst, for example, a polymerization method using a multi-site catalyst represented by a Ziegler-Natta type catalyst or a single-site catalyst represented by a metallocene-based catalyst.

Examples of the polypropylene-based resin that can be suitably used in the present invention include commercially available products such as trade names “NOVATEC PP”, “WINTEC”, and “WAYMAX” (manufactured by Japan Polypropylene Corporation), “VERSIFY”, “NOTIO”, and “TAFMER XR” (manufactured by Mitsui Chemicals, Inc.), “ZELAS” and “THERMORUN” (manufactured by Mitsubishi Chemical Corporation), “Sumitomo NOBLEN” and “Tafthren” (manufactured by Sumitomo Chemical Co., Ltd.), “Prime Polypro” and “Prime TPO” (manufactured by Prime Polymer Co., Ltd.), “Adflex”, “Adsyl”, and “HMS-PP (PF814)” (manufactured by SunAllomer Ltd.), and “INSPIRE” (manufactured by Dow Chemical).

### [β-Crystal Activity]

The electret film of the present invention is preferably formed of a resin composition containing, as a main component, a polypropylene-based resin containing a large amount of β-crystals, which is one of crystal morphologies. A non-porous film-like material formed of a resin composition containing a polypropylene-based resin containing a large amount of β-crystals as a main component exhibits excellent piezoelectricity by itself after a charging treatment, but more excellent piezoelectricity can also be obtained by stretching the non-porous film-like material to form a porous structure. In the formation of the porous structure using the β-crystal, since the porosity is formed in the process in which the β-crystal in the polypropylene-based resin is transferred to the α-crystal in the stretching process, the porous structure is dense and does not depend on the particle diameter or the dispersion diameter as compared with the porosity formed by the addition of the inorganic filler or the incompatible organic substance known in the related art, which is advantageous for the adjustment of the porous structure.

The β-crystal activity of the electret film of the present invention can be regarded as an indicator indicating that the polypropylene-based resin has formed β-crystals in the non-porous film-like material before stretching. When the polypropylene-based resin in the non-porous film-like material before stretching has formed β-crystals, many fine and uniform pores are formed by performing stretching thereafter, and therefore, excellent mechanical properties can be obtained, and excellent voltage resistance can be obtained due to the formation of fine and uniform pores.

The presence or absence of the β-crystal activity of the electret film of the present invention is determined by performing a differential thermal analysis of the electret film with a differential scanning calorimeter and determining whether a crystal melting peak temperature derived from the β-crystal of the polypropylene-based resin is detected.

Specifically, when the temperature of the laminated porous film is raised from 40° C. to 200° C. at a heating rate of 10° C./min and then held for 1 minute, then lowered from 200° C. to 40° C. at a cooling rate of 10° C./min and then held for 1 minute, and further raised again from 40° C. to 200° C. at a heating rate of 10° C./min using a differential scanning calorimeter, in a case where a crystal melting peak temperature (Tm) derived from the β-crystal of the polypropylene-based resin is detected at the time of re-raising, it is determined that the film has β-crystal activity.

The presence or absence of the β-crystal activity can also be determined by a diffraction profile obtained by X-ray diffractometry of an electret film subjected to a specific heat treatment. Specifically, the electret film is subjected to heat treatment at 170° C. to 190° C., which is a temperature exceeding the crystal melting peak temperature of the polypropylene-based resin, and slowly cooled to generate and grow β-crystals, and the electret film is subjected to X-ray diffractometry, and when a diffraction peak derived from the (300) plane of the β-crystals of the polypropylene-based resin is detected in a range of 2θ=16.0° to 16.5°, it is determined that the electret film has β-crystal activity. For details of the β-crystal structure and X-ray diffractometry of the polypropylene-based resin, Macromol. Chem. 187, 643 to 652 (1986), Prog. Polym. Sci. Vol. 16, 361 to 404 (1991), Macromol. Symp. 89, 499 to 511 (1995), Macromol. Chem. 75, 134 (1964), and references cited in these documents can be referred to.

Examples of the method for obtaining the β-crystal activity of the polypropylene-based resin include a method in which a material that promotes the formation of α-crystals of the polypropylene-based resin is not added, a method in which a polypropylene-based resin that has been subjected to a treatment for generating peroxide radicals as described in JP 3739481 B is added, and a method in which a β-crystal nucleating agent is added, and in the present invention, a particularly preferable method is to obtain the β-crystal activity by adding the β-crystal nucleating agent. By adding the β-crystal nucleating agent, the formation of β-crystals of the polypropylene-based resin can be promoted more uniformly and efficiently, and an electret film having β-crystal activity can be obtained.

The degree of the β-crystal activity can be quantified by measuring the β-crystal forming ability. The electret film preferably has a β-crystal forming ability of 80% or more, more preferably 85% or more, and further preferably 90% or more.

When the β-crystal forming ability is 80% or more, the laminated piezoelectric sheet can exhibit suitable piezoelectricity. The upper limit is not particularly limited, and is preferably 100% or less.

The β-crystal forming ability is calculated by a method described later.

### (2) β-Crystal Nucleating Agent

It is preferable that the electret film of the present invention contains a β-crystal nucleating agent in order to obtain excellent piezoelectricity. When the β-crystal nucleating agent is contained, β-crystal activity can be exhibited. Examples of the β-crystal nucleating agent used in the present invention include the following. If necessary, two or more kinds of β-crystal nucleating agents may be mixed and used.

Examples of the β-crystal nucleating agent include amide compounds; tetraoxaspiro compounds; quinacridones; iron oxides having a nanoscale size; alkali or alkaline earth metal salts of carboxylic acids typified by potassium 1,2-hydroxystearate, magnesium benzoate, magnesium succinate, magnesium phthalate, and the like; aromatic sulfonic acid compounds typified by sodium benzenesulfonate, sodium naphthalenesulfonate, and the like; di- or tri-esters of di- or tri-basic carboxylic acids; phthalocyanine pigments typified by phthalocyanine blue and the like; two component compounds composed of a component A which is an organic dibasic acid and a component B which is an oxide, a hydroxide, or a salt of a Group 2 metal in the periodic table; and compositions composed of a cyclic phosphorus compound and a magnesium compound.

Among these β-crystal nucleating agents, an amide compound is preferable. By using an amide compound in an electret film, piezoelectric characteristics can be enhanced. Examples of the amide compound include N,N′-dicyclohexyl-2,6-naphthalenedicarboxamide, N,N′-dicyclohexylterephthalamide, and N,N′-diphenylhexanediamide, and among them, N,N′-dicyclohexyl-2,6-naphthalenedicarboxamide is preferable. It is considered that since the amide compound has an amide group having high polarity, charges can be localized in the crystal structure, and high piezoelectric characteristics are exhibited.

On the other hand, there is a problem that a compound having a high polarity such as an amide compound has poor dispersibility due to electrostatic interaction with a polypropylene-based resin having a low polarity and is likely to aggregate. However, a general β-crystal nucleating agent has a characteristic of being dissolved in a polypropylene-based resin in a certain temperature range. Due to this characteristic, the β-crystal nucleating agent is uniformly dispersed in the polypropylene-based resin, and crystals derived from the β-crystal nucleating agent are likely to be uniformly precipitated therein. Therefore, it is considered that the crystals of the amide compound having high polarity are uniformly dispersed in the polypropylene-based resin having low polarity, and high piezoelectric characteristics can be obtained.

Specific examples of commercially available β-crystal nucleating agents include β-crystal nucleating agent “N Jester NU-100” manufactured by New Japan Chemical Co., Ltd., and specific examples of propylene-based resins to which a β-crystal nucleating agent is added include polypropylene “Bepol B-022SP” manufactured by Aristech, polypropylene “Beta (β)-PP BE60-7032” manufactured by Borealis, and polypropylene “BNX BETAPP-LN” manufactured by Mayzo.

The content of the β-crystal nucleating agent in the electret film of the present invention can be appropriately adjusted depending on the type of the β-crystal nucleating agent, the composition of the polypropylene-based resin, or the like, and is preferably 0.0001 to 5.0 parts by mass, more preferably 0.001 to 3.0 parts by mass, and further preferably 0.01 to 1.0 parts by mass, with respect to 100 parts by mass of the polypropylene-based resin. When the content is 0.0001 parts by mass or more, the β-crystal of the polypropylene-based resin can be sufficiently generated and grown at the time of production, sufficient β-crystal activity can be ensured, and even when the porous film is formed, sufficient β-crystal activity also can be ensured. Therefore, a porous electret film having desired piezoelectricity can be obtained by subjecting the porous film to a charging treatment. On the other hand, the addition of 5.0 parts by mass or less is preferred because it is economically advantageous and there is no bleeding of the β-crystal nucleating agent to the film surface.

### (3) Other Components

When the electret film of the present invention is a porous film, a foaming agent, a filler, or the like may be contained instead of the β-crystal nucleating agent or in addition to the β-crystal nucleating agent.

For example, when a porous film made by chemical or physical foaming is used as the electret film of the present invention, it is preferable to add a chemical foaming agent, a physical foaming agent, a supercritical fluid, a thermally expandable microcapsule, or the like to the main component resin. These may be used alone or in combination of two or more thereof.

In addition, when a film made porous by stretching is used as the electret film of the present invention, it is also preferable to add a resin that is incompatible with the main component resin, or an inorganic filler. Examples of the inorganic filler include calcium carbonate, calcium sulfate, barium carbonate, barium sulfate, titanium oxide, talc, clay, kaolinite, and montmorillonite.

In addition, the electret film of the present invention may appropriately contain additives, for example, various additives such as a heat stabilizer, an antioxidant, an ultraviolet absorber, a light stabilizer, a crystal nucleating agent, a colorant, an antistatic agent, a hydrolysis inhibitor, a lubricant, a flame retardant, a conductive agent, and an elastomer to the extent that the properties thereof are not impaired.

### (4) Physical Properties of Electret Film

The porosity of the electret film of the present invention is preferably 0% or more and 50% or less, more preferably more than 0% and 40% or less, further preferably 5% or more and 30% or less, and still further preferably 10% or more.

By setting the porosity of the electret film within the above range, the pressure resistance of the present laminated piezoelectric sheet becomes good.

In the present invention, the thickness of the piezoelectric film typified by the electret film is preferably 10 μm or more and 200 μm or less, more preferably 15 μm or more and 150 μm or less, and further preferably 20 μm or more and 120 μm or less.

When the thickness of the piezoelectric film is within the above range, the piezoelectric characteristics and handling properties of the present laminated piezoelectric sheet become good.

### <Triboelectric Film>

The triboelectric film becomes a film having an electric charge by a charging mechanism due to triboelectric power generation and exhibits a piezoelectric function by acting as a dielectric. The charging mechanism due to triboelectric power generation is featured by a structure in which two (a pair of) charging portions formed of triboelectric films face each other via a gap, and the triboelectric films come into contact with each other, separate from each other, rub against each other, and the like to generate a charging portion having a positive charge and a charging portion having a negative charge, thereby efficiently generating a charging voltage.

The material of the triboelectric film is not particularly limited as long as the material can have chargeability. Examples thereof include a polymer (resin), a non-metal substance, and a metal substance. Examples of the polymer include silicone resins such as polydimethylsiloxane (PDMS), fluororesins such as polytetrafluoroethylene (PTFE), polyimide, polyvinyl chloride, polystyrene, polyolefins such as polyethylene, and polypropylene, polyester resins such as polyethylene terephthalate (PET), polycarbonate resins, acrylic resins such as polymethyl methacrylate (PMMA), polyamide resins such as nylon, and cellulose.

Examples of the non-metal substance include oxides such as silica and alumina. In addition, examples of the metal substance include aluminum, iron, nickel, silver, gold, platinum, copper, chromium, titanium, molybdenum, indium metal, and alloys of these metals.

A silicone resin such as polydimethylsiloxane (PDMS), a fluorine resin such as polytetrafluoroethylene (PTFE), and a vinyl chloride resin such as polyvinyl chloride are preferable from the viewpoint of easily causing a charging mechanism due to triboelectric charging. A vinyl chloride resin such as polyvinyl chloride is more preferable from the viewpoint of good chargeability and good durability due to toughness as a triboelectric film.

### (Vinyl Chloride Resin)

The vinyl chloride resin according to the present invention has a Vicat softening temperature of preferably 75° C. or higher, more preferably 78° C. or higher, and further preferably 90° C. or higher. The upper limit is not particularly limited, but is usually 140° C. or lower, and preferably 130° C. or lower. By setting the Vicat softening temperature in the above range, the chlorination ratio tends to be high due to chlorine contained in the resin, and it becomes easy to induce high negative triboelectric series characteristics and to impart a high triboelectric voltage, which is preferable.

On the other hand, when the Vicat softening temperature is significantly lower than 75° C., the moldability is excellent, but the chlorination ratio is likely to be low, the negative triboelectric series characteristics are likely to deteriorate, and the triboelectric charging characteristics are likely to deteriorate. On the other hand, when the Vicat softening temperature is significantly higher than 140° C., the moldability is significantly deteriorated, and it is difficult to form a thin film.

As a specific structure, a chlorinated vinyl chloride resin described in WO 2013/081133 and page 74 of “PVC Fact Book” (edited by Vinyl Environmental Council, published in February 2005) which is a non-patent document is preferable from the viewpoint that a high Vicat softening temperature of 80° C. or higher is easily obtained.

Furthermore, as a method for obtaining a high Vicat softening temperature, resins other than vinyl chloride can be blended, but the blending of the resins decreases the chlorination ratio, and the triboelectric charging characteristics are likely to decrease. The Vicat softening temperature is measured in accordance with JIS K7206. Unless otherwise noted, the B50 method is used.

### (Silicone Resin)

The silicone resin according to the present invention is not particularly limited as long as it is a polymer compound having a main skeleton formed by a siloxane bond, and the molecular weight thereof is usually 2000 or more, and may be 4000 or more, and is usually 500000 or less, and may be 200000 or less.

In addition, the shape of the silicone resin is not particularly limited, but in the case of a film shape, the Shore A hardness may be 20° or more, and is preferably 40° or more. The upper limit of the Shore A hardness is preferably 90° or less. It is particularly preferably 40° or more and 70° or less.

In addition, the tensile strength of the silicone resin may be 5 MPa or more and may be 15 MPa or less. In addition, as the silicone resin, a resin generally called silicone rubber is preferable, and specifically, methyl silicone rubber, vinyl methyl silicone rubber, phenyl methyl silicone rubber, and the like are preferable.

### (Relative Permittivity)

The dielectric of the triboelectric film has a relative permittivity (εr) of preferably 2 or more, more preferably 3 or more, further preferably 5 or more, and particularly preferably 8 or more. There is no upper limit of the relative permittivity, and a higher relative permittivity is preferable. The relative permittivity can be calculated from the following equation (1) by forming electrodes on both surfaces of a layer of a material to be measured (specimen) to prepare a parallel plate capacitor and measuring the electrostatic capacitance C of the capacitor.

$$C = ε 0 \cdot ε r \cdot A / d \qquad ( 1 )$$

Here, εr is the relative permittivity, 80 is the permittivity of vacuum, A is the area of the capacitor, and d is the film thickness of the layer of the material to be measured. The electrostatic capacitance C of the capacitor can be measured by an LCR meter, an impedance analyzer, or the like.

The portion of the triboelectric film where friction is generated by contact is preferably made of the following materials as the outermost surface layer. That is, examples of the material of the outermost surface layer include a polymer, a non-metal substance, and a metal substance.

Examples of the polymer include those described above and a melamine resin. In addition, examples of the non-metal substance include oxides such as silica and alumina. Examples of the metal substance include aluminum, iron, nickel, silver, gold, platinum, copper, chromium, titanium, molybdenum, indium metal, and alloys of these metals.

As the two (a pair of) charging portions formed of the triboelectric films, a combination of the triboelectric films is not particularly limited as long as a charging portion having a positive charge and a charging portion having a negative charge are generated, and a combination of the triboelectric films formed of different materials is preferable from the viewpoint of easily charging the positive and negative charges. A combination of a triboelectric film made of a polymer (resin) and a triboelectric film made of a metallic material is more preferable because it tends to have good chargeability. Furthermore, when the electrode layer described later has charging performance, it can also function as one of the charging portions in a structure where the aforementioned two (pair of) charging portions face each other through a gap. From the viewpoint of reducing the film thickness in order to secure the flexibility of the laminated piezoelectric sheet and obtaining good chargeability, it is preferable to combine a triboelectric film made of a polymer (resin) and an electrode layer having charging performance.

### 2. Electrode

The laminated piezoelectric sheet of the present invention has at least one electrode. The electrode is preferably provided in at least two layers so as to sandwich the piezoelectric film.

The layer serving as an electrode may have conductivity, and an aluminum foil, a copper foil, a silver foil, a gold foil, a nickel foil, a tin foil, a carbon sheet, or the like is preferably used.

The materials exemplified above may be used as the electrode in a single layer, or a conductive layer made of the above materials may be laminated with other layers and used. For example, in order to improve the handleability of the electrode, a resin film may be provided on at least one surface of the conductive layer directly or via an adhesive layer.

The electrode has a raised pattern on a surface on a side in contact with the piezoelectric film. When the electrode surface has a raised pattern, a space can be formed between the piezoelectric film and the electrode, and therefore, when an external pressure is applied to the laminated piezoelectric sheet, the deformation is easily transmitted to the piezoelectric film, the signal intensity becomes favorable, and the in-plane variation of the signal intensity can be reduced.

The pattern expressed by the raised shape on the surface of the electrode on the side in contact with the piezoelectric film is not particularly limited, and examples thereof include ground patterns such as an orange peel pattern, a satin finished surface pattern, and a silky (fine grain) pattern, and geometric patterns such as a dot pattern, a lattice pattern, a mesh pattern, a diamond pattern, and a stripe pattern, and one type or two or more types may be combined. Among these, it is preferable to have at least one pattern selected from a dot pattern, a lattice pattern, a stripe pattern, and a combination thereof, and a dot pattern is more preferable.

When the electrode has a dot-shaped concave-convex pattern, examples of the shape of the concave-convex pattern in a top view include a pattern in which triangular convex portions or concave portions are arranged at appropriate intervals, a pattern in which quadrangular convex portions or concave portions are arranged at appropriate intervals, and a pattern in which circular convex portions or concave portions are arranged at appropriate intervals. Among these, a pattern in which convex portions are arranged at appropriate intervals on the surface on the side in contact with the piezoelectric film is preferable.

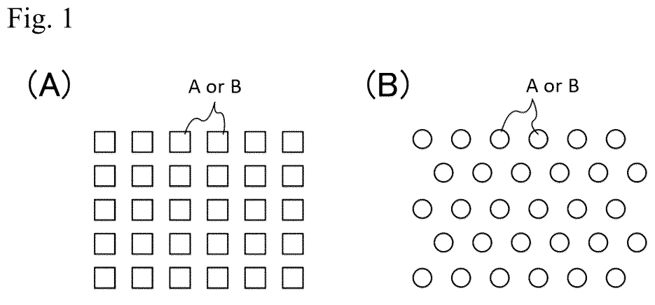

In addition, the concave-convex pattern may be arranged in a matrix of rows and columns as shown in FIG. 1. The concave portions or convex portions arranged in the matrix of rows and columns may be arranged exactly in a line along the columns (see FIG. 1(A)), or may be arranged substantially in a zigzag shape along the columns so that the positions of the concave portions or convex portions may be changed (see FIG. 1(B)). However, the present invention is not limited thereto.

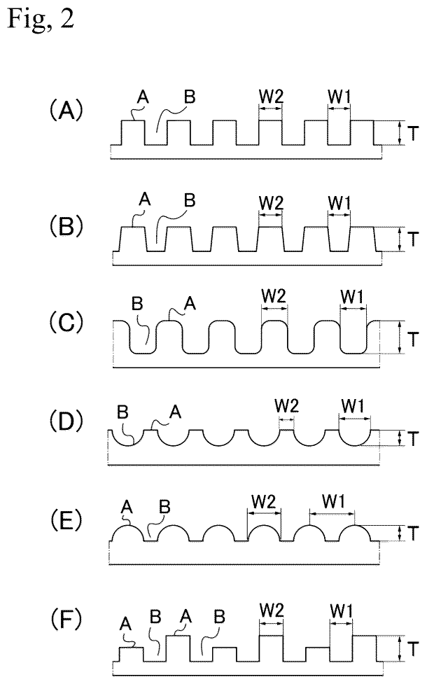

The cross-sectional shape of the concave-convex unit constituting the concave-convex pattern may be a repeating shape in which a concave portion or a convex portion may have any predetermined shape such as a triangular shape, a quadrangular shape, a trapezoidal shape, a semicircular shape or a semi-elliptical shape as the cross-sectional shape of the convex portion (see FIGS. 2(A) to 2(F)).

The value T, the height of the convex portion or the depth of the concave portion in the concave-convex pattern, is preferably 20 μm or more, and more preferably 25 μm or more. On the other hand, it is preferably 1000 μm or less, more preferably 800 μm or less, further preferably 500 μm or less, still further preferably 300 μm or less, and particularly preferably 150 μm or less.

When the height of the convex portion or the depth of the concave portion in the concave-convex pattern is equal to or more than the above lower limit value, a space can be formed between the piezoelectric film and the electrode, and therefore, when an external pressure is applied to the laminated piezoelectric sheet, the deformation is easily transmitted to the piezoelectric film, so that the signal intensity becomes favorable. On the other hand, when the height of the convex portion or the depth of the concave portion in the concave-convex pattern is equal to or less than the above upper limit value, even in a case where the electrode and the piezoelectric film are bonded to each other at the end portion when the piezoelectric film is used as a sensor, the thickness difference between the bonded portion and the convex portion of the electrode is not too large, and thus, the in-plane variation of the signal intensity is reduced.

Here, the height of the convex portion or the depth of the concave portion means a vertical length based on the highest portion and the lowest portion in the concave-convex unit when the electrode having the concave-convex pattern is viewed in a vertical cross section cut in the thickness direction along the arrangement of the concave-convex pattern.

Since the height of the convex portion is also the depth of the concave portion, it is not necessary to strictly distinguish the height of the convex portion from the depth of the concave portion in most cases.

In addition, in the concave-convex pattern, an interval (W1) between adjacent convex portions is preferably 40 mm or less, more preferably 30 mm or less, further preferably 20 mm or less, still further preferably 15 mm or less, and particularly preferably 10 mm or less. On the other hand, it is preferably 1 mm or more, more preferably 2 mm or more, and further preferably 5 mm or more.

When the interval between adjacent convex portions is equal to or less than the above upper limit value, a space is easily formed between the piezoelectric film and the electrode, and thus the in-plane variation of the signal intensity is reduced. On the other hand, when the interval between adjacent convex portions is equal to or more than the above lower limit value, the contact area between the piezoelectric film and the electrode does not become too small, so that the signal intensity becomes good.

The interval between adjacent convex portions is the average value of the intervals between adjacent convex portions when the concave-convex pattern is viewed from the top. The interval between adjacent convex portions or the interval between adjacent concave portions does not necessarily need to be constant. In a case where the boundary of the convex portion is indefinite, such as in the case of an inclined raised pattern, the average value of the intervals with reference to the top of the convex portion is used.

The maximum width (W2) of the convex portions in the concave-convex pattern is preferably 0.5 mm or more, more preferably 1 mm or more, and further preferably 2 mm or more. On the other hand, it is preferably 40 mm or less, more preferably 30 mm or less, and further preferably 20 mm or less.

In addition, the maximum width of the convex portion in the concave-convex pattern is the average value of the lengths of the maximum widths of the respective convex portions when the concave-convex pattern is viewed from the top. For example, when the shape of the convex portion in the concave-convex unit in a top view is a circle, the maximum width is the diameter, and when the shape is a square, the maximum width is the length of the diagonal.

The maximum cross-sectional height (Rt) on the surface of the electrode on the side in contact with the piezoelectric film is preferably 20 μm or more, and more preferably 25 μm or more. On the other hand, it is preferably 1000 μm or less, more preferably 800 μm or less, further preferably 500 μm or less, still further preferably 300 μm or less, and particularly preferably 150 μm or less.

When the maximum cross-sectional height (Rt) on the electrode surface is equal to or more than the above lower limit value, a space can be formed between the piezoelectric film and the electrode, and therefore, when an external pressure is applied to the laminated piezoelectric sheet, the deformation is easily transmitted to the piezoelectric film, so that the signal intensity becomes favorable. On the other hand, when the maximum cross-sectional height (Rt) on the electrode surface is equal to or less than the above upper limit value, even in a case where the electrode and the piezoelectric film are bonded to each other at the end portion when the piezoelectric film is used as a sensor, the thickness difference between the bonded portion and the convex portion of the electrode is not too large, and thus, the in-plane variation of the signal intensity is reduced.

The maximum cross-sectional height (Rt) on the electrode surface can be obtained by the method described in Examples using a contact type roughness meter.

In addition, in a case where the electrode has a geometrically concave-convex pattern, the maximum cross-sectional height (Rt) on the electrode surface is a value measured along the central portion of the arrangement of the concave-convex pattern. In a case where the concave-convex pattern has a stripe shape, it is a value obtained by measuring in a direction orthogonal to the stripe.

The concave-convex average interval (Sm) on the surface of the electrode on the side in contact with the piezoelectric film is preferably 40 mm or less, more preferably 30 mm or less, further preferably 20 mm or less, still further preferably 15 mm or less, and particularly preferably 10 mm or less. On the other hand, it is preferably 1 mm or more, more preferably 2 mm or more, and further preferably 5 mm or more.

In a case where the concave-convex average interval (Sm) on the electrode surface is equal to or less than the above upper limit value, a space is easily formed between the piezoelectric film and the electrode, and thus the in-plane variation of the signal intensity is reduced. On the other hand, in a case where the concave-convex average interval (Sm) on the electrode surface is equal to or more than the above lower limit value, the contact area between the piezoelectric film and the electrode does not become too small, so that the signal intensity becomes good.

The concave-convex average interval (Sm) can be determined by a method described in Examples using a contact type roughness meter. When the electrode has a concave-convex pattern, the concave-convex average interval (Sm) on the electrode surface is a value measured along the central portion of the arrangement of the concave-convex pattern. In a case where the concave-convex pattern has a stripe shape, it is a value obtained by measuring in a direction orthogonal to the stripe.

As described above, the balance between the maximum cross-sectional height (Rt) and the concave-convex average interval (Sm) is important from the viewpoint of obtaining a favorable signal intensity and from the viewpoint of reducing the in-plane variation of the signal intensity. In this respect, the ratio (Rt/Sm) of the maximum cross-sectional height (Rt) to the concave-convex average interval (Sm) is preferably 2.5×10⁻³ or more, more preferably 3.0×10⁻³ or more, further preferably 3.5×10⁻³ or more, and still further preferably 4.0×10⁻³ or more. On the other hand, it is preferably 35×10⁻³ or less, more preferably 30×10⁻³ or less, further preferably 25×10⁻³ or less, still further preferably 20×10⁻³ or less, and particularly preferably 10×10⁻³ or less.

In a case where the electrode has a laminated configuration of a conductive layer and the other layer, only the conductive layer may have concave and convex, or both the conductive layer and the other layer may have concave and convex. Among these, from the viewpoint of easily forming a space between the piezoelectric film and the electrode, a configuration in which both the conductive layer and the other layer have concave and convex is preferable.

The thickness of the electrode is preferably 2 μm or more and 100 μm or less, more preferably 3 μm or more and 50 μm or less, and further preferably 5 μm or more and 30 μm or less.

In a case where the thickness of the electrode is 2 μm or more, the electrode can exhibit conductive stability. On the other hand, in a case where the thickness of the electrode is 100 μm or less, the flexibility of the laminated piezoelectric sheet can be enhanced.

The thickness of the electrode is measured by observing a cross section of the electrode with a scanning electron microscope (SEM), measuring 10 points at random, and calculating an average value thereof.

### 3. Protective Film

The laminated piezoelectric sheet of the present invention may have at least one protective film in order to prevent deterioration or the like of the piezoelectric film and the electrode due to moisture, and preferably has a laminated structure in which at least the piezoelectric film, the electrode, and the protective film are provided in this order. By providing the protective film, it is possible to impart water resistance to the laminated piezoelectric sheet without using a special material for the porous electret film, and thus it is possible to prevent deterioration of piezoelectric characteristics due to humidity.

The protective film is preferably provided so as to cover the piezoelectric film and the electrode from the viewpoint of enhancing the water resistance of the present laminated piezoelectric sheet.

Further, it is more preferable that the protective film is provided in at least two layers in the present laminated piezoelectric sheet in order to protect both the front and back surfaces of the piezoelectric film and the electrode.

In the present laminated piezoelectric sheet, the product of the flexural modulus and the thickness of the protective film is preferably 80 kN/m or more and 10 MN/m or less. When the product of the flexural modulus and the thickness is within the above range, there is an effect that deflection or lifting can be suppressed and the in-plane signal accuracy is stabilized when a laminated piezoelectric sheet is formed. When the product of the flexural modulus and the thickness of the protective film is equal to or more than the above lower limit value, the signal stability is improved. On the other hand, when the product is equal to or less than the above upper limit value, there is an effect that the laminated piezoelectric sheet can be easily carried and handled. The range is more preferably 100 KN/m or more and 9 MN/m or less, further preferably 120 KN/m or more and 8 MN/m or less, and particularly preferably 150 kN/m or more and 6 MN/m or less.

The upper limit value or the lower limit value can be arbitrarily combined.

The flexural modulus of the protective film is preferably 1000 MPa or more and 20000 MPa or less, more preferably 1500 MPa or more and 18000 MPa or less, and further preferably 2000 MPa or more and 16000 MPa or less. When the flexural modulus is equal to or more than the above lower limit value, it is possible to suppress a variation in signal while keeping the protective film thin, and when the flexural modulus is equal to or less than the above upper limit value, it is possible to allow a sufficient displacement amount for signal detection.

As the protective film, a resin film such as a polyester-based resin film, a polyolefin-based resin film, an acrylic-based resin film, a polystyrene-based resin film, a polycarbonate-based resin film, and a fluororesin film can be suitably used, and from the viewpoint of thermal weldability, films obtained by laminating hot-melt resins on these films can also be used. These films can be easily obtained as commercially available laminate films.

A pressure-sensitive adhesive may be applied to one surface of the protective film of the present invention. Since it is possible to perform cold lamination in which two sheets of protective film are prepared and the protective films are bonded to each other with the adhesive surfaces on the inner side, lamination can be performed without applying heat as compared with hot lamination on the heat fusion side, and therefore, a laminated piezoelectric sheet can be produced without causing thermal damage.

The thickness of the protective film of the present invention is preferably 1 μm or more and 100 μm or less, more preferably 5 μm or more and 50 μm or less, further preferably 10 μm or more and 40 μm or less, and still further preferably 20 μm or more and 30 μm or less.

In a case where the thickness of the protective film is 1 μm or more, water resistance of the present laminated piezoelectric sheet can be imparted. On the other hand, in a case where the thickness of the protective film is 100 μm or less, the pressure applied to the present laminated piezoelectric sheet is easily propagated to the piezoelectric film, and the flexibility of the present laminated piezoelectric sheet can be secured.

On the other hand, the thickness of the protective film is preferably 80 μm or more and 2 mm or less, more preferably 100 μm or more and 1.5 mm or less, and further preferably 120 μm or more and 1.2 mm or less, from the viewpoint that the signal accuracy of the laminated piezoelectric sheet is improved and further sufficient water resistance can be imparted while securing the flexibility of the laminated piezoelectric sheet.

### 4. Others

The laminated piezoelectric sheet of the present invention may be provided with an electrode tab, a shield layer, a spacer, an adhesive layer, a buffer layer, and the like, in addition to the above-described constituent members, for the purpose of improving handling properties and electrical characteristics when the laminated piezoelectric sheet is formed into a device.

The present laminated piezoelectric sheet preferably has an electrode tab in order to conduct the electrode to other electronic components or the like. The electrode tab may have any configuration as long as it is provided so as to be connected to the electrode, and may be formed on, for example, a protective film, a piezoelectric film, or disposed so as to be sandwiched between the protective film and the piezoelectric film.

When multiple electrodes are provided, for example, the electrode tabs may be provided according to the number of electrode layers, and when two electrodes are provided, for example, two electrode tabs may be provided according to the number of electrode layers.

In addition, the present laminated piezoelectric sheet preferably has an adhesive layer in order to prevent a decrease in piezoelectric characteristics due to a positional deviation of the electrode.

In a case where the present laminated piezoelectric sheet has an adhesive layer, the adhesive layer may be provided between the electrode and the protective film or may be provided between the piezoelectric film and the electrode. However, in order not to deteriorate the piezoelectric characteristics of the piezoelectric film, it is preferable that the adhesive layer is provided between the electrode and the protective film.

In a case where the adhesive layer is provided between the electrode and the protective film, it is possible to prevent the electrode from protruding from the ends of the piezoelectric film, being in contact with other electrode, and being short-circuited, and it is possible to impart good piezoelectric characteristics to the laminated piezoelectric sheet. From the above viewpoint, the covering area of the adhesive layer between the electrode and the protective film is preferably 80% or more, more preferably 90% or more, and further preferably 100% of the area of the electrode.

On the other hand, it is preferable that an adhesive layer is not provided between the piezoelectric film and the electrode or the adhesive layer has a minimum area.

When the electrode is bonded to the piezoelectric film with an adhesive layer, it is possible to prevent the positional deviation of the electrode at the time of producing the laminated piezoelectric sheet or the like. However, when the piezoelectric film is a porous electret film, the piezoelectric characteristics of the laminated piezoelectric sheet may be impaired for the reason that an adhesive constituting the adhesive layer may penetrate into the pores, or the like. In addition, even when the electrode is not bonded to the piezoelectric film, if the electrode is bonded to the protective film, the movement of the electrode is regulated at the time of production or the like, and thus, the positional deviation with respect to the piezoelectric film can also be prevented.

From the above viewpoint, the ratio (Aa/Ae) of the covering area Aa of the adhesive layer between the electrode and the piezoelectric film to the area Ae of the electrode is preferably more than 0 and 0.5 or less, more preferably more than 0 and 0.4 or less, and further preferably more than 0 and 0.3 or less in a case where the adhesive layer is provided. When Aa/Ae is equal to or more than the above lower limit value, it is possible to prevent the positional deviation of the electrode at the time of producing the laminated piezoelectric sheet, or the like. On the other hand, when Aa/Ae is equal to or less than the above upper limit value, it is possible to suppress the deterioration of the piezoelectric characteristics of the laminated piezoelectric sheet.

From the viewpoint of suppressing the positional deviation between the electrode and the piezoelectric film, it is preferable that an adhesive layer is partially provided between the electrode and the piezoelectric film. Especially, from the viewpoint of ensuring a space formed by the concave and convex of the electrode surface, it is preferable that an adhesive layer is partially provided between the electrode and the piezoelectric film. Examples of partially providing the adhesive layer include a method of disposing the adhesive layer at four corners, long sides, or short sides of the electrode and the piezoelectric film, or disposing the adhesive layer in a circular shape, a square shape, or a linear shape at intervals. Two or more of these arrangements may be used in combination.

The material of the adhesive layer is not particularly limited, and in a case where the material does not have pressure-sensitive adhesiveness, examples of the adhesive constituting the adhesive layer include a thermosetting adhesive, a photocurable adhesive, a hot-melt adhesive, and a moisture-curable adhesive. When the adhesive layer is a pressure-sensitive adhesive layer, it is preferable to use various pressure-sensitive adhesives such as an acrylic pressure-sensitive adhesive, a urethane pressure-sensitive adhesive, a synthetic rubber pressure-sensitive adhesive, a natural rubber pressure-sensitive adhesive, and a silicone pressure-sensitive adhesive.

The pressure-sensitive adhesive layer preferably has conductivity from the viewpoint of enhancing conduction stability of the electrode. Examples of the method for imparting conductivity include a method of blending conductive particles such as metal powder particles of gold, silver, copper, nickel, aluminum, or the like; conductive carbon particles of carbon, graphite, or the like; and particles having a metal coating on the surface of a core material such as a resin, solid glass beads, hollow glass beads, or the like, into an adhesive or a pressure-sensitive adhesive.

Among the above, from the viewpoint of conductivity and adhesiveness, an acrylic conductive pressure-sensitive adhesive in which metal powder particles such as nickel powder particles, copper powder particles, and silver powder particles are blended is preferable.

In addition, the shape of the conductive particles is not particularly limited, and may be a spherical shape, a surface needle-like shape, or the like, or may be a shape in which multiple conductive particles are connected with each other with forming a bond or the like therebetween.

The conductive particles may be used alone or may be used in combination of two or more kinds thereof.

The content of the conductive particles in the conductive pressure-sensitive adhesive may be appropriately adjusted so as to impart desired conductivity, and is preferably 1% by mass or more and 50% by mass or less, more preferably 5% by mass or more and 25% by mass or less, and further preferably 8% by mass or more and 20% by mass or less.

The thickness of the adhesive layer is not particularly limited, and is preferably 1 μm or more and 100 μm or less, more preferably 2 μm or more and 50 μm or less, and further preferably 4 μm or more and 35 μm or less from the viewpoint of ensuring the adhesiveness between the protective film and the electrode without increasing the thickness of the present laminated piezoelectric sheet more than necessary.

In addition, an adhesive tape in which an adhesive layer is laminated in advance on one surface of the electrode may be used, and for example, an adhesive tape in which an adhesive layer is laminated on one surface of a metal foil such as a copper foil or an aluminum foil may be used. As such an adhesive tape, a commercially available product may be used, and for example, “E-2300ND”, “E20CU”, “E30CU”, “E40CU”, “E50CU”, “E65CU”, “52050AD”, and the like manufactured by DIC Corporation can be used.

### 5. Layer Configuration of Laminated Piezoelectric Sheet

As described above, the laminated piezoelectric sheet of the present invention is formed by laminating an electrode on at least one surface of a piezoelectric film.

The present laminated piezoelectric sheet is preferably provided with a protective film on at least one outermost layer in order to improve water resistance.

In addition, as described above, the present laminated piezoelectric sheet preferably has a configuration in which a piezoelectric film is disposed between two electrodes.

Furthermore, the present laminated piezoelectric sheet more preferably has a laminated structure in which at least a protective film, an electrode, a piezoelectric film, an electrode, and a protective film are provided in this order.

In the laminated structure with two layers of protective film, two sheets of protective film may be provided and the two layers of protective film may each be formed from a different protective film, or a single protective film may be provided and one sheet of protective film may be folded, for example, to form two layers of protective film with the one sheet of protective film.

In a case where the electrodes have a laminated configuration of the conductive layer and the other layer, the conductive layer and the piezoelectric film may be laminated so as to face each other, or the other layer and the piezoelectric film may be laminated so as to face each other. It is preferable to laminate the conductive layer and the piezoelectric film so that they face each other, as this facilitates efficient functioning as an electrode.

In addition, in a case where the present laminated piezoelectric sheet has two electrodes and has an adhesive layer, at least one of the electrodes may be bonded to the protective film via the adhesive layer, and from the viewpoint of further preventing the deviation of the electrodes and improving the piezoelectric characteristics, it is preferable that the adhesive layer is interposed respectively between each of the two electrodes and each of the protective films.

Therefore, in the case of having two electrodes, the present laminated piezoelectric sheet preferably has a laminated structure in which at least a protective film, an adhesive layer, an electrode, a piezoelectric film, an electrode, an adhesive layer, and a protective film are provided in this order.

At least the protective film, the electrode, the piezoelectric film, the electrode, the adhesive layer, and the protective film may be provided in this order, and the adhesive layer may not be provided between one of the protective films and the electrode. In this case, one of the protective films and the electrode may be directly laminated.

In addition, the piezoelectric film and the electrode may be directly laminated without interposing another layer, or another layer other than the adhesive layer, such as a spacer, may be interposed. Therefore, the electrode does not need to be bonded to the piezoelectric film. The spacer is a member for maintaining a constant interval between the electrode and the piezoelectric film, and is, for example, a resin frame hollowed out in a circular shape or a square shape.

Therefore, in a case where the present laminated piezoelectric sheet has two electrodes, each of both electrodes may be directly laminated on the piezoelectric film, or each of both electrodes may be laminated on the piezoelectric film via a layer interposed therebetween which is other than the adhesive layer, such as a spacer.

In addition, one electrode and the piezoelectric film may be directly laminated, and the other electrode and the piezoelectric film may be laminated via a layer interposed therebetween which is other than the adhesive layer, such as a spacer.

### <Method for Producing Laminated Piezoelectric Sheet>

A method for producing the laminated piezoelectric sheet of the present invention will be described, but the following description is an example of a method for producing the laminated piezoelectric sheet of the present invention, and the laminated piezoelectric sheet of the present invention is not limited to a laminated piezoelectric sheet produced by such a production method.

The laminated piezoelectric sheet of the present invention is produced by preparing a piezoelectric film and laminating the piezoelectric film and an electrode. Note that other steps and processes may be further included.

### 1. Method for Producing Electret Film

The electret film of the present invention is preferably produced through a film forming step, a stretching step, and a charging treatment step. However, the stretching step may be omitted.

Hereinafter, the film forming step, the stretching step, and the charging treatment step will be sequentially described.

### (1) Film Forming Step

In the film forming step, a non-porous film-like material made of a material constituting the electret film is formed. The film forming method is not particularly limited, and examples thereof include a method in which a resin (material resin) constituting the electret film is heated and melted to form a film. Specific examples thereof include a T-die method and an inflation method, and among these, it is preferable to adopt the T-die method. Practically, it is preferable that the material resin is melt-extruded from a T-die and cast-molded by a cast roll (chill roll, cast drum, or the like).

In addition, the material resin may be formed into a film as a resin composition containing two or more components obtained by appropriately blending an additive or mixing two or more resin components.

The material constituting the electret film may be formed into a film after being kneaded in a kneading device. When kneading is performed, a kneading apparatus to be used is not particularly limited. For example, a known extruder such as a single-screw extruder, a twin-screw extruder, or a multi-screw extruder can be used.

In addition, in the extruder, a pressure reducing machine may be connected to a vent port according to the facility structure and necessity to remove moisture and a low molecular weight substance from the material constituting the electret film.

As a specific method for forming a film, when a T-die method is adopted, a method in which a sheet-shaped molten resin extruded from a T-die is extruded onto a cast roll and taken up while being brought into close contact with a rotating cast roll to form a film-shaped product can be mentioned.

In order to adhere the film-shaped product to the cast roll, a touch roll, an air knife, an electric adhesion device, or the like may be attached to the cast roll.

When the molten resin (resin composition) is formed into a film while being cooled, the temperature of the cast roll is preferably 100° C. or higher. The temperature of the cast roll is more preferably 110° C. or higher, and further preferably 120° C. or higher. In the present invention, since the porosity can be increased also by opening pores in the crystalline portion and the amorphous portion of the polypropylene-based resin during the stretching step, it is preferable to set the temperature of the cast roll to 100° C. or higher to obtain a non-porous film-like material having a high crystallinity.

On the other hand, the upper limit of the cast roll temperature is preferably 140° C. or lower. It is more preferably 135° C. or lower, and further preferably 130° C. or lower. By setting the temperature of the cast roll to 140° C. or lower, peeling from the cast roll at the time of film forming becomes easy.

In the obtained non-porous film-like material, the thickness of the effective portion excluding both end portions is preferably 30 μm or more and 500 μm or less, more preferably 40 μm or more and 300 μm or less, and further preferably 50 μm or more and 200 μm or less.

When the thickness of the non-porous film-like material is 30 μm or more, breakage at the time of stretching can be prevented, and when the thickness of the non-porous film-like material is 500 μm or less, stretching of the non-porous film-like material can be easily performed.

The layer configuration of the non-porous film-like material of the electret film is not limited to the above-described single layer configuration, and may be a configuration in which other layers are combined.

### (2) Stretching Step

The obtained non-porous film-like material may be subjected to a charging treatment as it is, or the non-porous film-like material may be subjected to a stretching treatment. By performing a stretching treatment to the non-porous film-like material, the non-porous film-like material can be easily made into a porous film.

In the stretching step, the non-porous film-like material is preferably subjected to uniaxial stretching or biaxial stretching, and uniaxial stretching is preferred in order to adjust the porosity of the electret film to a suitable range. The uniaxial stretching may be longitudinal uniaxial stretching or transverse uniaxial stretching. The biaxial stretching may be simultaneous biaxial stretching or sequential biaxial stretching.

The stretching in the flow direction (MD) of the film-like material is referred to as “longitudinal stretching”, and the stretching in the direction (TD) perpendicular to the flow direction is referred to as “transverse stretching”.

The stretching temperature needs to be appropriately selected depending on the composition, the crystal melting peak temperature, the crystallinity, and the like of the resin composition to be used, and the longitudinal stretching temperature is preferably 60 to 140° C., and more preferably 80 to 120° C.

When the longitudinal stretching temperature is 140° C. or lower, the film can be stretched without breaking at a temperature equal to or lower than the melting point of the polypropylene-based resin that is a suitable main component, which is preferable. On the other hand, when the longitudinal stretching temperature is 60° C. or higher, breakage at the time of stretching can be suppressed, which is preferable.

The transverse stretching temperature is preferably 90 to 160° C. and more preferably 100 to 150° C. As the transverse stretching temperature is within the specified range, the pores generated at the time of the longitudinal stretching are enlarged to increase the porosity, so that sufficient piezoelectric characteristics can be obtained.

The temperature described above is a temperature in the case of uniaxial stretching or sequential biaxial stretching, but the stretching temperature in the case of simultaneous biaxial stretching may be adjusted within a range of preferably 90° C. or higher and 140° C. or lower, and more preferably 100° C. or higher and 120° C. or lower from the above viewpoint.

The stretching ratio may be arbitrarily selected in accordance with the desired porosity, and the stretching ratio per uniaxial stretching is preferably 1.1 times or more and 10 times or less, more preferably 1.5 times or more and 9.0 times or less, and further preferably 1.5 times or more and 8.0 times or less.

When the stretching ratio per uniaxial stretching is 1.1 times or more, whitening proceeds, and the porosity is sufficiently formed by stretching. On the other hand, when the stretching ratio per uniaxial stretching is 10 times or less, the porosity does not become too high, and an electret film having excellent pressure resistance can be obtained.

In addition, in the case of sequential biaxial stretching, by stretching at the above-specified stretching ratio for each axis, the pores generated at the time of the previous stretching are not deformed at the time of the subsequent stretching.

### (3) Charging Treatment

The electret film of the present invention can be obtained by subjecting the non-porous film-like material obtained in the film forming step or the porous film obtained through the stretching step to a charging treatment. The charging treatment may be a continuous type or a batch type. The charging treatment may be a method of passing the film between electrodes such as a needle-shaped electrode, a wire electrode, a roll-shaped electrode, and a plate-shaped electrode and applying an electric field between the electrodes, or may be a method of forming electrodes directly on the front and back surfaces of the film by coating or vapor deposition and then applying an electric field.

The electric field to be applied is preferably 0.1 MV/m or more and 10 MV/m or less, more preferably 0.2 MV/m or more and 8 MV/m or less, and further preferably 0.3 MV/m or more and 6 MV/m or less. When it is 0.1 MV/m or more, it is possible to have excellent piezoelectric characteristics. When it is 10 MV/m or less, it is possible to reduce dielectric breakdown at the time of charging treatment.

Further, the piezoelectric film of the present invention may be subjected to surface processing such as corona treatment, plasma treatment, printing, coating, and vapor deposition, and perforation processing as necessary, and several piezoelectric films of the present invention can be stacked depending on the application.

### 2. Method for Producing Electrode

The method for forming concave and convex on the surface of the electrode is not particularly limited, and examples thereof include processing with an embossing roll, press molding processing, and cutting processing. In the processing with an embossing roll or the press molding processing, the processing may be performed while heating the electrode in order to facilitate formation of the concave and convex on the surface of the electrode.

Alternatively, the concave and convex may be formed by partially stacking a conductive material on the surface of the electrode.

Among the above, from the viewpoint of enabling continuous production of the laminated piezoelectric sheet of the present invention, processing with an embossing roll is preferred.

### 3. Method for Producing Laminated Piezoelectric Sheet

The laminated piezoelectric sheet of the present invention can be obtained by laminating the piezoelectric film produced by the method described above and the electrode. The order of lamination is preferably the order of the electrode and the piezoelectric film from the outside.

In a case where the laminated piezoelectric sheet includes the protective film, for example, in order to obtain a laminated configuration in which the protective film, the electrode, the piezoelectric film, the electrode, and the protective film are provided in this order, it is preferable that a pressure-sensitive adhesive is applied to one surface of the protective film, two sets of laminates in which the protective film and the electrode are bonded together with the pressure-sensitive adhesive are prepared, the two laminates are overlapped with each other so that the two electrodes can face each other with the piezoelectric film interposed therebetween, and peripheral portions of the protective films are bonded to each other with the pressure-sensitive adhesive to seal the laminated piezoelectric sheet.

In addition, in the present laminated piezoelectric sheet, it is preferable that the piezoelectric film, the electrode, and the protective film are laminated, and then the end portions of the protective film are bonded to form a bag shape. The method of bonding the end portions is not limited to bonding with a pressure-sensitive adhesive, and a heat sealing or the like may be applied.

In the case of forming a bag shape, it is preferable to provide respectively two layers of the electrode and two layers of the protective film, and for example, it is preferable to laminate the protective film, the electrode, the piezoelectric film, the electrode, and the protective film in this order, and bond the end portions of the protective films to each other with a pressure-sensitive adhesive to form a bag shape.

When two sheets of protective film are used, the end portions of the two sheets of protective film may be partially bonded to each other in advance before the lamination.

### <Sensor Device>

The laminated piezoelectric sheet of the present invention can be made into a sensor device by providing a lead wire or circuit mounting.

Since the present laminated piezoelectric sheet is excellent in water resistance and piezoelectric characteristics, as a sensor device including the present laminated piezoelectric sheet, vibration power generation, a water level gauge, an acoustic detector, a mat sensor, a robot hand, and the like are preferable.

### EXAMPLES

The laminated piezoelectric sheet of the present invention will be described in more detail below with reference to Examples and Comparative Examples, but the present invention is not limited in any way.

The materials used in Examples and Comparative Examples are as follows.

### (Polypropylene-Based Resin)

A-1: Homopolypropylene (NOVATEC PP FY6HA, MFR: 2.4 g/10 min [230° C., 2.16 kg load], Mw/Mn=3.2, manufactured by Japan Polypropylene Corporation) (β-Crystal nucleating agent)
B-1: N,N′-dicyclohexyl-2,6-naphthalenedicarboxamide (NU-100, manufactured by New Japan Chemical Co., Ltd.) (Antioxidant)
C-1: A 1:1 mixture of tris(2,4-di-t-butylphenyl)phosphite and tetrakis [3-(3′,5′-di-t-butyl-4′-hydroxyphenyl) propionic acid]pentaerythritol (IRGANOX-B225, manufactured by BASF)

### (Formation of Electret Film)

One hundreds parts by mass of polypropylene-based resin (A-1), 0.2 parts by mass of β-crystal nucleating agent (B-1), and 0.1 parts by mass of antioxidant (C-1) were mixed and melt-extruded at 280° C. using a twin-screw extruder to obtain an electret film mixture 1. The electret film mixture 1 was put into an extruder connected to a T-die with a lip opening of 1 mm, and molded, and was introduced into a cast roll to obtain a non-porous film-like material with a thickness of 340 μm. Then, in a film tenter facility (manufactured by Kyoto Machine Co., Ltd.), the film was stretched 5 times in the transverse direction at a stretching temperature of 120° C. to obtain a porous film with a thickness of 80 μm. The porosity of the obtained porous film was 18%, and the β crystal activity was 85%.

The obtained porous film was placed on an earth plate and charged with a voltage of −15 kV using a wire electrode with a distance between electrodes of 30 mm, to obtain an electret film. The moving speed of the wire electrode was 40 mm/sec.

### Example 1-1

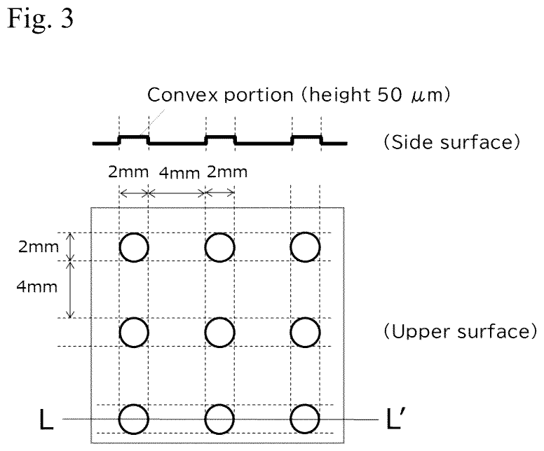

As an electrode, a conductive copper foil adhesive tape “E20CU” (manufactured by DIC Corporation, electrode thickness 9 μm, adhesive layer thickness 11 μm) was heated and fed between a pair of embossing rolls to form concave and convex on the surface of the electrode on the side in contact with the piezoelectric film. The embossing rolls formed the pattern shown in FIG. 3. Table 1 shows the maximum cross-sectional height (Rt) and the concave-convex average interval (Sm) at the position corresponding to line L-L′ in FIG. 3 for the surface of the electrode on the side in contact with the piezoelectric film.

50 μm-thick cold laminate film having a base material layer made of polyethylene terephthalate resin and a pressure-sensitive adhesive layer made of an acrylic pressure-sensitive adhesive was cut into two pieces with 11 cm square to prepare cutouts as the protective film.

The electrode was cut into a 9 cm square and bonded to the adhesive face side of the protective film. At this time, the electrode had an electrode tab formed thereon so as to easily connect to a signal output wire, and the electrode was set to protrude about 1 cm from the protective film.

Thereafter, a piezoelectric film cut to a size of 10 cm square was sandwiched between the two electrodes so that the film did not protrude from the electrodes, and the end portions of the protective films were bonded together to produce a laminated piezoelectric sheet.

### Example 1-2

A laminated piezoelectric sheet was produced in the same manner as in Example 1-1, except that a commercially available conductive embossed copper foil tape (manufactured by 3M, “2245”) was used as the electrode.

### Examples 1-3 to 1-8

A laminated piezoelectric sheet was produced in the same manner as in Example 1-1, except that the method for forming concave and convex on the surface of the electrode was changed as described below and the maximum cross-sectional height (Rt) and the concave-convex average interval (Sm) were adjusted so as to be as shown in Table 1.

### (Method of Forming Concave and Convex)

A conductive copper foil adhesive tape “E20CU” was punched into a circle having a diameter of 6 mm to prepare a circular tape. The obtained circular tape punched to a diameter of 6 mm was attached at equal intervals on the conductive copper foil adhesive tape “E20CU” to prepare an electrode having a dot pattern in which circular convex portions were arranged.

The height of the convex portions was adjusted by stacking multiple circular tapes, and the interval between the convex portions was adjusted by changing the interval between the circular tapes to be attached.

### Example 1-9

A laminated piezoelectric sheet was produced in the same manner as in Example 1-1, except that an electrode was used in which a conductive copper foil adhesive tape “E20CU” (manufactured by DIC Corporation, electrode thickness 9 μm, adhesive layer thickness 11 μm) was heated and fed between a pair of embossing rolls to form silky concave and convex on the surface of the electrode on the side in contact with the piezoelectric film.

### Example 1-10

A laminated piezoelectric sheet was produced in the same manner as in Example 1-1, except that a polyvinylidene fluoride film having a thickness of 80 μm (KF Piezofilm, manufactured by Kureha Corporation) was used as the piezoelectric film. The piezoelectric film is a permanent dipole type electret film polarized by the dipole orientation of the polymer itself.

### Comparative Example 1-1

A laminated piezoelectric sheet was produced in the same manner as in Example 1-1, except that a conductive copper foil adhesive tape “E20CU” was used as the electrode without being embossed.

### Comparative Example 1-2

A laminated piezoelectric sheet was produced in the same manner as in Comparative Example 1-1, except that a polyvinylidene fluoride film having a thickness of 80 μm (KF Piezofilm, manufactured by Kureha Corporation) was used as the piezoelectric film.

The laminated piezoelectric sheets obtained in Examples and Comparative Examples were measured and evaluated by the following methods.

### (1) Maximum Cross-Sectional Height (Rt) and Concave-Convex Average Interval (Sm)

The maximum cross-sectional height (Rt) and the concave-convex average interval (Sm) on the surface of the electrode on the side in contact with the piezoelectric film were measured using a contact-type two-dimensional surface roughness meter under the following conditions. The measurement was carried out three times and the average value was calculated.
Measuring device: Surfcorder ET-4000A (manufactured by Kosaka Laboratory Ltd.)
Measurement length: 8 mm
Measurement speed: 0.1 mm/s
Measurement load: 100 μN
Needle tip diameter: 0.5 μm
Cutoff value: 0.8 mm

### (2) Thickness

Using a 1/1000 mm dial gauge, the thicknesses of the protective film and piezoelectric film were measured at 10 random points and the average value of each was obtained.

The thickness of the electrode was also measured at 10 random points by observing the cross section with a scanning electron microscope (SEM) and the average value was obtained.

### (3) Porosity

The piezoelectric film was cut into a size of 100 mm in width×100 mm in length to prepare a measurement sample. The actual mass W1 of the measurement sample was measured, and the mass W0 when the porosity was 0% was calculated based on the density of the resin composition, and the porosity was calculated from these values based on the following equation.

$$Porosity ( \% ) = \{ ( W 0 - W 1 ) / W 0 \} \times 100$$

### (4) β-Crystal Forming Ability

DSC measurements of piezoelectric films were performed using the following method. First, the temperature was raised from 40° C. to 200° C. at a rate of 10° C./min under a nitrogen atmosphere, held for 1 minute, and then cooled to 40° C. at a rate of 10° C./min. With respect to the melting peaks observed when the temperature was raised again at 10° C./min after holding for 1 minute, the melting peak in the temperature range of 145 to 157° C. was the melting peak of β-crystal, and the melting peak observed at 158° C. or higher was the melting peak of α-crystal. The heat of melting of each was determined from the area surrounded by the peak and a baseline drawn based on the flat part on the high temperature side. The heat of melting of α-crystals was defined as ΔHα, and the heat of melting of β-crystals was defined as ΔHβ, and the β-crystal formation ability was calculated using the following equation.

$$β - crystal forming ability ( \% ) = [ Δ H β / ( Δ H α + Δ H β ) ] \times 100$$

### (5) Signal Intensity (Output Voltage)

The laminated piezoelectric sheet was placed on a horizontal table and fixed with cellophane tape. In this state, a ping-pong ball with a diameter of 40 mm and a weight of 2.4 g was dropped vertically from a point 30 cm high, and the peak value of the output voltage generated at that time was measured using an oscilloscope (“TBS1072B” manufactured by Tektronix, Inc.). The measurements were carried out five times, with the ping-pong ball being dropped into five locations: one in the center of the laminated piezoelectric sheet and four locations near each corner. From the five measured values, the average value and standard deviation of the output voltage peak value were calculated, and the coefficient of variation was calculated using the following equation.

$$Coefficient of variation = ( standard deviation ) / ( average value )$$

Table 1 and Table 2 show the evaluation results for Examples and Comparative Examples.

TABLE 1

| | | | Example 1-1 | Example 1-2 | Example 1-3 | Example 1-4 |
|---|---|---|---|---|---|---|
| Piezoelectric film | | | PP | PP | PP | PP |
| Electrode surface shaping | | | Yes | Yes | Yes | Yes |
| Electrode | Maximum cross- | [μm] | 30 | 50 | 30 | 60 |
| | sectional height (Rt) | | | | | |
| | Concave-convex | [mm] | 6.4 | 1.9 | 8.9 | 12.7 |
| | average interval (Sm) | | | | | |
| | Rt/Sm | [×10⁻³] | 4.7 | 26.8 | 3.4 | 4.7 |

| | | | | | |
|---|---|---|---|---|---|
| Output voltage | [V] | 44.3 | 17.9 | 41.7 | 18.6 |
| (average of 5 times) | | | | | |
| Coefficient of variation | [V] | 0.32 | 0.27 | 0.29 | 0.33 |

| | | | Example 1-5 | Example 1-6 | Example 1-7 |
|---|---|---|---|---|---|
| Piezoelectric film | | | PP | PP | PP |
| Electrode surface shaping | | | Yes | Yes | Yes |
| Electrode | Maximum cross- | [μm] | 120 | 30 | 900 |
| | sectional height (Rt) | | | | |
| | Concave-convex | [mm] | 12.7 | 12.7 | 12.7 |
| | average interval (Sm) | | | | |
| | Rt/Sm | [×10⁻³] | 9.4 | 2.4 | 70.9 |

| | | | | |
|---|---|---|---|---|
| Output voltage | [V] | 37.0 | 20.5 | 49.8 |
| (average of 5 times) | | | | |
| Coefficient of variation | [V] | 0.33 | 0.47 | 0.50 |

TABLE 2

| | | | Example | Example | Example | Comparative | Comparative |
|---|---|---|---|---|---|---|---|
| | | | 1-8 | 1-9 | 1-10 | Example 1-1 | Example 1-2 |
| Piezoelectric film | | | PP | PP | PVDF | PP | PVDF |
| Electrode surface shaping | | | Yes | Yes | Yes | No | No |
| Electrode | Maximum cross- | [μm] | 30 | 19 | 30 | 2 | 2 |
| | sectional height Rt | | | | | | |
| | Concave-convex | [mm] | 50.0 | 0.5 | 6.4 | 0.1 | 0.1 |
| | average interval Sm | | | | | | |
| | Rt/Sm | [×10⁻³] | 0.6 | 35.6 | 4.7 | 46.2 | 46.2 |

| | | | | | | |
|---|---|---|---|---|---|---|
| Output voltage | [V] | 5.2 | 3.5 | 32.3 | 0.6 | 0.7 |
| (average of 5 times) | | | | | | |
| Coefficient of variation | [V] | 0.73 | 0.12 | 0.59 | 0.33 | 0.42 |

It was confirmed from Examples 1-1 to 1-10 that a laminated piezoelectric sheet having a raised pattern on the surface, in which concave and convex are formed on the surface of the electrode on the side in contact with the piezoelectric film, provided good signal intensity. It was also confirmed that when the maximum cross-sectional height (Rt) and the concave-convex average interval (Sm) on the surface of the electrode on the side in contact with the piezoelectric film are within a specific range, the signal intensity (output voltage) is good and there is little in-plane variation of the signal intensity. In particular, in Examples 1 to 5, it was confirmed that the in-plane variation of the signal intensity was further reduced by setting the ratio Rt/Sm of the maximum cross-sectional height (Rt) to the concave-convex average interval (Sm) within a specific range.

On the other hand, in Comparative Examples 1 and 2, a raised pattern was not formed on the surface of the electrode, and the height of the concave-convex of the electrode was insufficient, so that a sufficient space was not formed between the piezoelectric film and the electrode, resulting in a low signal intensity.

### Example 2-1

One hundreds parts by mass of polypropylene-based resin (A-1), 0.2 parts by mass of β-crystal nucleating agent (B-1), and 0.1 parts by mass of antioxidant (C-1) were mixed and melt-extruded at 280° C. using a twin-screw extruder to obtain a resin composition. The resin composition was put into an extruder connected to a T-die with a lip opening of 1 mm, and molded, and was introduced into a cast roll to obtain a non-porous film-like material with a thickness of 300 μm. Then, in a film tenter facility (manufactured by Kyoto Machine Co., Ltd.), the film was stretched 7 times in the transverse direction at a stretching temperature of 100° C. to obtain a porous film. The obtained porous film had a porosity of 20%.

The obtained porous film was placed on an earth plate and charged with a voltage of −15 kV using a needle-shaped electrode with a distance between electrodes of 30 mm, to obtain a porous electret film having a thickness of 60 μm. The porous electret film had β-crystal activity, and the β-crystal forming ability of the polypropylene-based resin contained in the porous electret film was 92%.

As a protective film, a polyester film having a thickness of 200 μm (“DIAFOIL T-100” manufactured by Mitsubishi Chemical Corporation) was prepared. Two sheets of protective film cut into 21 cm square were prepared, and a conductive copper foil embossed tape (manufactured by 3M, electrode thickness 30 μm) cut into 19 cm square was bonded to the inside of each protective film as an electrode having an adhesive layer on one side, and then electrode tabs to connect to each electrode were formed on each protective film. Then, a porous electret film cut into 20 cm square was sandwiched between the electrodes of the two sheets of protective film with electrodes so that the electrodes did not protrude from the outer periphery of the film, and the end portions of the four sides were bonded to the protective films on both sides with 10 mm wide double-sided tape to prepare a laminated piezoelectric sheet. The electrode tabs extended from the inside to the outside of a bag formed by bonding the protective film and the porous electret film.

### Example 2-2

A laminated piezoelectric sheet was obtained in the same manner as in Example 1-1, except that the protective film was changed to a polycarbonate sheet having a thickness of 0.5 mm (manufactured by Mitsubishi Gas Chemical Company, Inc.: N-7S-C0.5).

### Reference Example 1

A laminated piezoelectric sheet was obtained in the same manner as in Example 1-1, except that the protective film was changed to a polyethylene film having a thickness of 70 μm (manufactured by KOKUGO Co., Ltd.).

### Reference Example 2

A laminated piezoelectric sheet was obtained in the same manner as in Example 1-1, except that the protective film was changed to a polyester film having a thickness of 25 μm (“DIAFOIL T-100” manufactured by Mitsubishi Chemical Corporation).

### Reference Example 3

A laminated piezoelectric sheet was obtained in the same manner as in Example 1, except that a 20 cm square double-sided tape was used instead of the 10 mm wide double-sided tape, and electrodes were bonded to both sides of the porous electret.

The laminated piezoelectric sheets obtained in Examples 2-1 and 2-2 and Reference Examples 1 to 3 were measured for electromotive force and signal stability by the following methods.

### (6) Flexural Modulus

The protective film was layered to a thickness of 3 mm and heat pressed, and then three test pieces with a width of 25 mm and a length of 60 mm were cut out in accordance with JIS K7171:2008. The initial modulus of elasticity of each of the three test pieces obtained was measured using a Tensilon universal tensile tester RTC-1250A-PL (manufactured by A&D Company, Limited) at room temperature of 22° C., a span width of 48 mm, and a pressing speed of 1 mm/min, and the average value of the initial modulus of elasticity of the three test pieces was calculated as the flexural modulus (MPa).

### (7) Electromotive Force

Using a rubber-like probe with a cylindrical shape of ϕ 10 mm, which imitates a human finger, a load of 100 gf was repeatedly applied to and removed from the laminated piezoelectric sheet at intervals of 2 cm, and the electromotive force generated during this process was measured with an oscilloscope, and the absolute values of the measured values at 81 points were taken to calculate the average value. For the sake of convenience, the electromotive force was assumed to be less than 1 mV for those that could not be measured due to large noise.

### (8) Signal Stability

Using a rubber-like probe with a cylindrical shape of ϕ 10 mm, which imitates a human finger, a load of 100 gf was repeatedly applied to and removed from the laminated piezoelectric sheet at intervals of 2 cm, and the electromotive force generated during this process was measured with an oscilloscope, and the positive and negative peaks of 81 points were recorded. The proportion of the signal where the positive and negative were inverted (signal inversion rate) was calculated, and the signal stability was evaluated according to the following evaluation criteria.

### (Evaluation Criteria)

A (good): 1% or less of the signal where the positive and negative were inverted
B (poor): More than 1% of the signal where the positive and negative were inverted

Table 3 shows the evaluation results for Examples and Comparative Examples.

TABLE 3

| Example | Example | Reference | Reference | Reference |
|---|---|---|---|---|
| 2-1 | 2-2 | Example 1 | Example 2 | Example 3 |

Porous electret

| | | | | | | |
|---|---|---|---|---|---|---|
| Material | — | PP | PP | PP | PP | PP |

Adhesive layer

| | | | | | | |
|---|---|---|---|---|---|---|
| Area Aa | [mm²] | 3900 | 3900 | 3900 | 3900 | 40000 |

Electrode

| | | | | | | |
|---|---|---|---|---|---|---|
| Material | — | Cu | Cu | Cu | Cu | Cu |
| Area Ae | [mm²] | 36100 | 36100 | 36100 | 36100 | 36100 |
| Aa/Ae | — | 0.11 | 0.11 | 0.11 | 0.11 | 1.11 |

Protective Film

| | | | | | | |
|---|---|---|---|---|---|---|
| Material | — | PEs | PC | PE | PEs | PEs |
| Flexural modulus | [MPa] | 2200 | 2300 | 850 | 2200 | 2200 |
| Thickness | [mm] | 0.2 | 0.5 | 0.07 | 0.025 | 0.2 |
| (Flexural modulus) × | [kN/m] | 440 | 1150 | 60 | 55 | 440 |
| (thickness) | | | | | | |
| Electromotive force | [V] | 10 | 9 | 11 | 8 | 0.2 |
| Signal inversion rate | [%] | 0 | 0 | 23 | 21 | 0 |
| Signal stability | — | A | A | B | B | A |

From Examples 2-1 and 2-2, it was found that the laminated piezoelectric sheet exhibited good signal stability when it had a laminated structure in which a piezoelectric film, an electrode, and a protective film were provided in this order, and the product of the flexural modulus and thickness of the protective film was 80 kN/m or more and 10 MN/m or less. These laminated piezoelectric sheets also had high electromotive force and showed good piezoelectric characteristics.

On the other hand, in Reference Examples 1 and 2, since the product of the flexural modulus and thickness of the protective film was small, there was a tendency for the signal stability to be lower than in Examples 2-1 and 2-2.

In Reference Example 3, since an adhesive layer was provided on the entire surface of the electret film, the signal stability was good, but the electromotive force was reduced. That is, a comparison of Examples 2-1 and 2-2 with Reference Example 3 suggests that reducing the area covered by the adhesive layer on the electrodes can improve signal stability and improve piezoelectric characteristics.

### REFERENCE SIGNS LIST

A: Convex portion
B: Concave portion
T: Height of convex portion or depth of concave portion
W1: Interval between adjacent convex portions
W2: Maximum width of convex portion

1. A laminated piezoelectric sheet comprising an electrode laminated on at least one surface of a piezoelectric film, wherein the electrode has a raised pattern on a surface on a side in contact with the piezoelectric film.

2. The laminated piezoelectric sheet according to claim 1, wherein the laminated piezoelectric sheet has an electrode laminated on at least one surface of a piezoelectric film, a maximum cross-sectional height (Rt) on a surface of the electrode on a side in contact with the piezoelectric film is 20 μm or more, and a concave-convex average interval (Sm) is 40 mm or less.

3. The laminated piezoelectric sheet according to claim 1, wherein a ratio (Rt/Sm) of the maximum cross-sectional height (Rt) to the concave-convex average interval (Sm) on a surface of the electrode on a side in contact with the piezoelectric film is 2.5×10⁻³ or more and 35×10⁻³ or less.

4. The laminated piezoelectric sheet according to claim 1, wherein the surface of the electrode on a side in contact with the piezoelectric film has at least one pattern shape selected from a dot shape, a lattice shape, a stripe shape, and a combination thereof.

5. The laminated piezoelectric sheet according to claim 1, wherein the piezoelectric film is an electret film.

6. The laminated piezoelectric sheet according to claim 5, wherein the electret film has a porosity of 0% or more and 50% or less.

7. The laminated piezoelectric sheet according to claim 5, wherein the electret film is a porous film.

8. The laminated piezoelectric sheet according to claim 5, wherein the electret film contains a polyolefin-based resin as a main component.

9. The laminated piezoelectric sheet according to claim 8, wherein the polyolefin-based resin is a polypropylene-based resin having a β-crystal forming ability of 80% or more.

10. The laminated piezoelectric sheet according to claim 1, wherein the piezoelectric film has a thickness of 10 μm or more and 200 μm or less.

11. The laminated piezoelectric sheet according to claim 1, having a laminated structure in which the piezoelectric film, the electrode, and a protective film are provided in this order, wherein a product of a flexural modulus and a thickness of the protective film is 80 kN/m or more and 10 MN/m or less.

12. The laminated piezoelectric sheet according to claim 1, wherein the piezoelectric film and the electrode are not adhered to each other.

13. The laminated piezoelectric sheet according to claim 1, further comprising an adhesive layer between the piezoelectric film and the electrode, wherein a ratio (Aa/Ae) of a covering area Aa of the adhesive layer to an area Ae of the electrode is more than 0 and 0.5 or less.

14. A sensor device comprising the laminated piezoelectric sheet according to claim 1.
